(19) United States
(12) Patent Application Publication
(10) Pub. No.: US 2025/0162576 A1
(43) Pub. Date: May 22, 2025

(54) SYSTEM AND METHOD FOR MANAGING DRIVING NEGOTIATION MESSAGE FOR MINIMAL RISK MANEUVER

(71) Applicant: ELECTRONICS AND TELECOMMUNICATIONS RESEARCH INSTITUTE, Daejeon (KR)

(72) Inventors: Sangwoo LEE, Daejeon (KR); Yongbon Koo, Daejeon (KR); Ki Tae Kim, Daejeon (KR); Sung Hoon Kim, Daejeon (KR); JINWOO KIM, Daejeon (KR); MYUNGWOOK PARK, Daejeon (KR); KYOUNG HWAN AN, Daejeon (KR)

(21) Appl. No.: 18/909,258

(22) Filed: Oct. 8, 2024

(30) Foreign Application Priority Data
Nov. 16, 2023 (KR) 10-2023-0158741
Nov. 16, 2023 (KR) 10-2023-0158742

(51) Int. Cl. B60W 30/09

(52) U.S. Cl. CPC B60W 30/09; B60W 2720/106

(57) ABSTRACT

Disclosed are a system and method for managing a driving negotiation message for a minimal risk maneuver. The system includes an input interface device configured to receive driving negotiation target information, memory in which a program that generates a driving negotiation message by considering the driving negotiation target information and transmits the driving negotiation message has been stored, and a processor configured to execute the program. The processor generates the driving negotiation message by considering a minimal risk maneuver mode.

### CROSS-REFERENCE TO RELATED APPLICATION(S)

This application claims priority to and the benefit under 35 USC § 119 of Korean Patent Application 'No. 10-2023-0158741 filed on Nov. 16, 2023, and Korean Patent Application 'No. 10-2023-0158742 filed on Nov. 16, 2023, in the Korean Intellectual Property Office, the entire disclosures of which are incorporated herein by reference for all purposes.

### BACKGROUND

### 1. Technical Field

The present disclosure relates to a system and method for managing a driving negotiation message for a minimal risk maneuver.

### 2. Description of Related Art

Recently, various types of autonomous driving systems, such as an autonomous driving shuttle, a robotaxi, and a self-driving cleaning car, are developed. Various autonomous driving services according to the development of the autonomous driving systems are provided. The autonomous driving system provides an autonomous driving service within a predefined operational design domain (ODD). However, a case in which safety is not guaranteed may occur due to an unexpected situation, such as when an operation of the autonomous driving system falls outside an operation condition that was considered when the autonomous driving system was designed, when a failure occurs in the autonomous driving system or an autonomous vehicle, or when a user requests the end of a normal service. In such a case, there is a need for measures capable of securing minimal safety.

In the autonomous driving technical field, research is actively carried out to enable safer autonomous driving through driving negotiations using V2X communication. There is a limit to identifying a surrounding vehicle's driving intention through autonomous driving based on various types of sensors. There is a problem in that a dangerous situation is caused when an emergency situation occurs.

### SUMMARY

Various embodiments are directed to providing a system and method for managing a driving negotiation target for driving negotiations when performing a minimal risk maneuver (MRM) for achieving a minimal risk condition (MRC) if an autonomous driving system cannot drive normally due to an emergency situation occurred in the autonomous driving system.

Furthermore, various embodiments are directed to providing a system and method for generating and transmitting a message suitable for a driving negotiation target vehicle.

The present disclosure relates to a system and method for managing a driving negotiation message for a minimal risk maneuver.

A system for managing a driving negotiation message for a minimal risk maneuver according to an embodiment of the present disclosure includes an input interface device configured to receive driving negotiation target information, memory in which a program that generates a driving negotiation message by considering the driving negotiation target information and transmits the driving negotiation message has been stored, and a processor configured to execute the program. The processor generates the driving negotiation message by considering a minimal risk maneuver mode.

The processor generates the driving negotiation message for collision warning and a path change request when the minimal risk maneuver mode corresponds to an emergency stop.

The processor generates the driving negotiation message including at least any one of an acceleration request, a deceleration request, and a path change request by considering the driving negotiation target information when the minimal risk maneuver mode corresponds to a going-straight stop.

The processor generates the driving negotiation message including at least any one of a going-straight request, an acceleration request, and a path change request by considering the driving negotiation target information when the minimal risk maneuver mode corresponds to an ego vehicle lane stop.

The processor generates the driving negotiation message including at least any one of a going-straight request, an acceleration request, a deceleration request, and a path change request by considering the driving negotiation target information when the minimal risk maneuver mode corresponds to a right lane stop.

A method of managing a driving negotiation message for a minimal risk maneuver according to an embodiment of the present disclosure includes steps (A) of receiving driving negotiation target information and a minimal risk maneuver mode and (B) of generating a driving negotiation message by considering the driving negotiation target information and the minimal risk maneuver mode.

The step (B) includes generating the driving negotiation message for collision warning and a path change request when the minimal risk maneuver mode corresponds to an emergency stop.

The step (B) includes generating the driving negotiation message including at least any one of an acceleration request, a deceleration request, and a path change request by considering the driving negotiation target information when the minimal risk maneuver mode corresponds to a going-straight stop.

The step (B) includes generating the driving negotiation message including at least any one of a going-straight request, an acceleration request, and a path change request by considering the driving negotiation target information when the minimal risk maneuver mode corresponds to an ego vehicle lane stop.

The step (B) includes generating the driving negotiation message including at least any one of a going-straight request, an acceleration request, a deceleration request, and a path change request when the minimal risk maneuver mode corresponds to a right lane stop.

According to the embodiments of the present disclosure, a minimal risk maneuver for handling an emergency situation which occurs while an autonomous driving service is provided can be performed more safely and rapidly because a driving negotiation target is managed and a driving negotiation message is transmitted based on information on a surrounding vehicle and a high precision map.

Effects of the present disclosure which may be obtained in the present disclosure are not limited to the aforementioned effects, and other effects not described above may be evidently understood by those skilled in the art from the following description.

### BRIEF DESCRIPTION OF THE DRAWINGS

FIG. 1 illustrates minimal risk maneuver modes (e.g., for an emergency stop, a going-straight stop, an ego vehicle lane stop, and a right lane stop), which are determined by a minimal risk maneuver function unit when an emergency situation occurs according to an embodiment of the present disclosure.

FIG. 2 illustrates a common driving environment for an autonomous vehicle.

FIGS. 3A to 3E illustrate the generation of a driving negotiation target list when an emergency situation occurs according to an embodiment of the present disclosure.

FIG. 4 illustrates a process of selecting a driving negotiation target and transmitting a driving negotiation message according to an embodiment of the present disclosure.

FIG. 5 illustrates a driving negotiation system for minimal risk maneuver modes according to an embodiment of the present disclosure.

FIG. 6 illustrates a driving negotiation target vehicle and a driving negotiation message when a minimal risk maneuver mode for an emergency stop is performed according to an embodiment of the present disclosure.

FIG. 7 illustrates a driving negotiation target vehicle and a driving negotiation message when a minimal risk maneuver mode for a going-straight stop is performed according to an embodiment of the present disclosure.

FIG. 8 illustrates a driving negotiation target vehicle and a driving negotiation message when a minimal risk maneuver mode for an ego vehicle lane stop is performed according to an embodiment of the present disclosure.

FIG. 9 illustrates a driving negotiation target vehicle and a driving negotiation message when the minimal risk maneuver mode for the ego vehicle lane stop is performed according to an embodiment of the present disclosure.

FIG. 10 is a block diagram illustrating a computer system for implementing the method according to an embodiment of the present disclosure.

### DETAILED DESCRIPTION

The aforementioned object, other objects, advantages, and characteristics of the present disclosure and a method for achieving the objects, advantages, and characteristics will become clear with reference to embodiments to be described in detail along with the accompanying drawings.

However, the present disclosure is not limited to embodiments disclosed hereinafter, but may be implemented in various different forms. The following embodiments are merely provided to easily notify a person having ordinary knowledge in the art to which the present disclosure pertains of the objects, constructions, and effects of the present disclosure. The scope of rights of the present disclosure is defined by the writing of the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other components, steps, operations and/or components in addition to mentioned components, steps, operations and/or components.

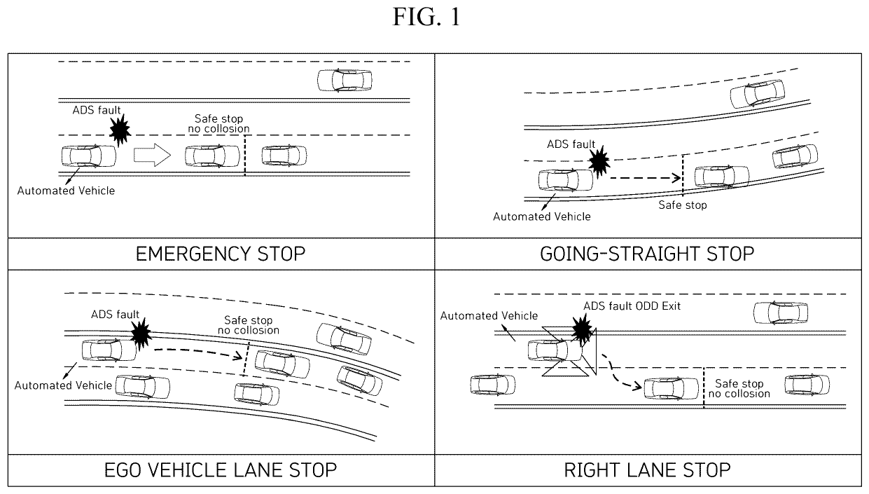

FIG. 1 illustrates minimal risk maneuver modes (e.g., for an emergency stop, a going-straight stop, an ego vehicle lane stop, a right lane stop shoulder parking, and safety zone parking), which are determined by a minimal risk maneuver function unit when an emergency situation occurs according to an embodiment of the present disclosure.

The emergency stop is an action to suddenly stop an ego vehicle in an ego vehicle driving lane when a forward collision risk occurs or a severe error occurs in a system, and requires a deceleration function.

The going-straight stop is an action to slowly stop an ego vehicle after going straight when it is difficult to maintain its current lane because an error occurs in a steering device in an emergency situation, and requires a deceleration function and a forward object recognition function.

The ego vehicle lane stop is an action to stop an ego vehicle while maintaining an ego vehicle driving lane when it is impossible to change its current lane in an emergency situation, and requires a longitudinal/transverse control function and a forward object recognition function.

The right lane stop is an action to stop an ego vehicle in a right lane of a driving lane in a situation in which the ego vehicle cannot travel up to a shoulder or a safe zone in an emergency situation, and requires a longitudinal/transverse control function and a forward/rightward object recognition function.

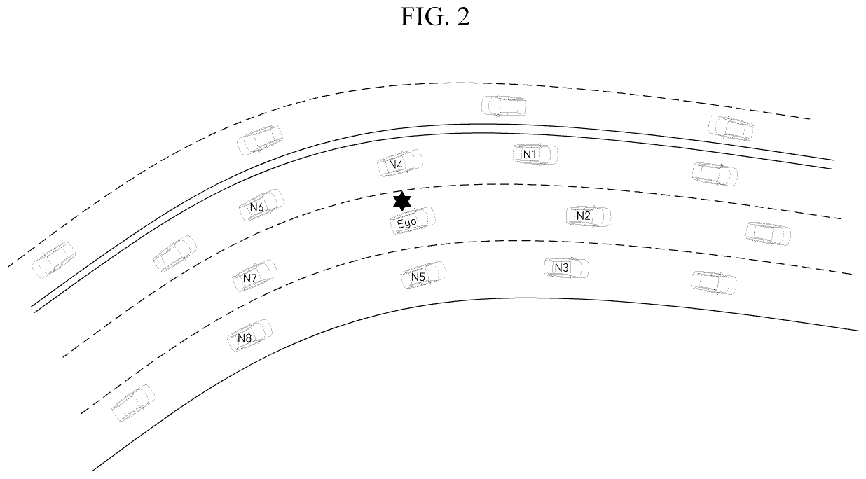

FIG. 2 illustrates a common driving environment for an autonomous vehicle.

When an emergency situation occurs in an ego vehicle, the ego vehicle performs the minimal risk maneuver mode depending on a surrounding situation and a cause and state that generate an emergency situation.

If driving negotiations using V2X are not used, an autonomous driving system checks driving conditions, based on surrounding object information that is collected by sensors and a high precision map.

A vehicle N7 which travels behind an ego vehicle Ego has a risk of a secondary accident that the vehicle N7 collides against the back of the ego vehicle when the ego vehicle suddenly stops like an emergency stop.

When the ego vehicle attempts a lane change as the minimal risk maneuver for the right lane stop, the ego vehicle may have a difficulty in performing the right lane stop if a vehicle N5 does not recognize the lane change and travels in parallel to the ego vehicle.

In such a case, if driving negotiations through the exchange of information between the ego vehicle and the vehicle N7 or N5 are possible, the minimal risk maneuver mode may be performed more safely and smoothly.

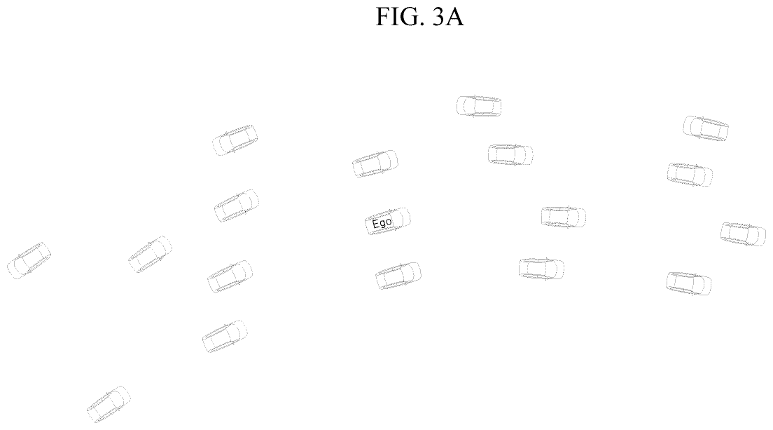

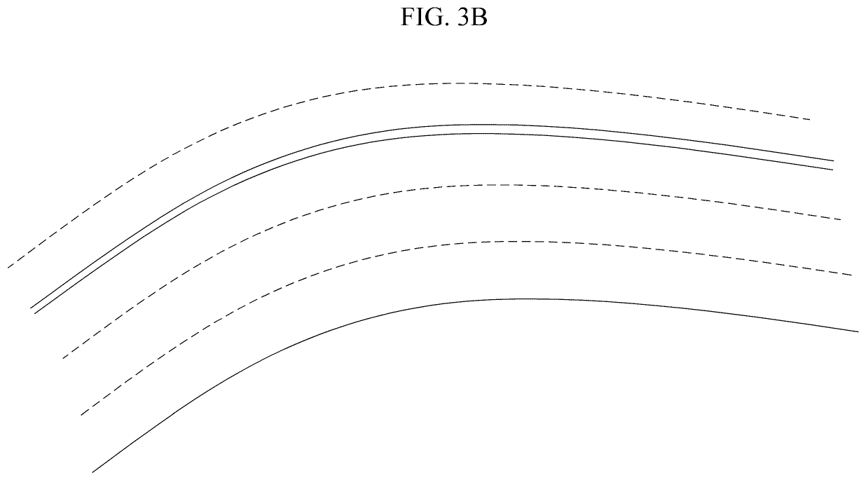

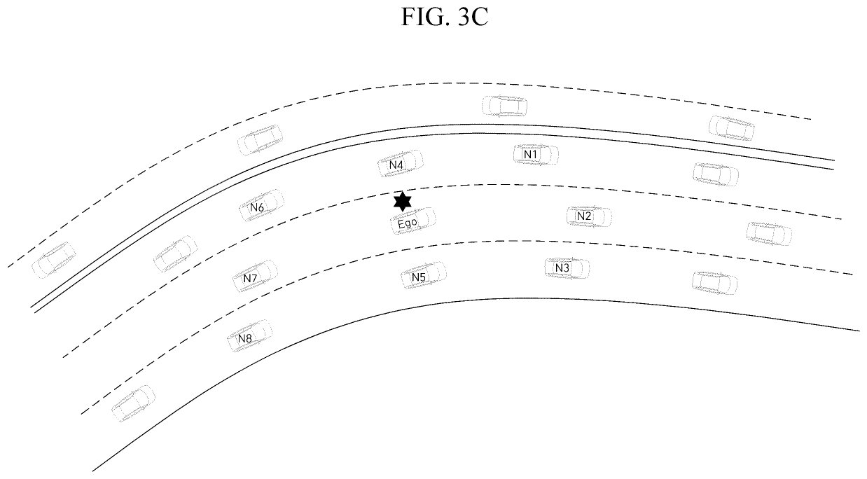

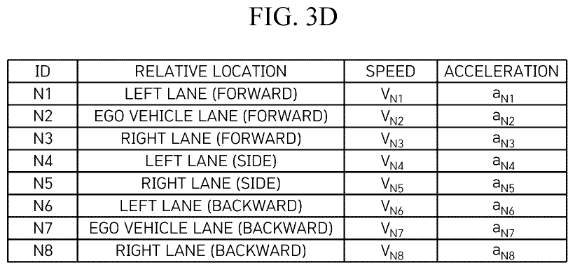

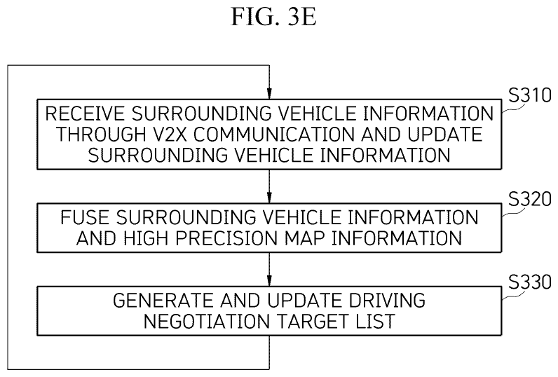

FIGS. 3A to 3E illustrate the generation of a driving negotiation target list when an emergency situation occurs according to an embodiment of the present disclosure.

A vehicle in which a V2X device has been installed periodically transmits a J2735 BSM message.

An ego vehicle receives a BSM message that is transmitted by the V2X device of another vehicle within an area in which the ego vehicle can communicate with the other vehicle, and manages the BSM message. Information that is obtained through V2X communication includes information, such as an absolute location, a speed, acceleration, and a heading angle. Information, such as that illustrated in FIG. 3A, may be generated.

However, information, such as that illustrated in FIG. 3A, is meaningless without road information because driving conditions according to a road structure cannot be checked.

In order to check whether a vehicle is placed ahead of the driving lane of an ego vehicle, in a side lane of the driving lane of an ego vehicle, or in a lane opposite to the driving lane of an ego vehicle, high precision map information, such as that illustrated in FIG. 3B, is required.

Information based on which a driving negotiation target may be selected as illustrated in FIG. 3C is generated by fusing information that is obtained through V2X communication and high precision map information.

When a surrounding vehicle is checked, information on a front, side, or rear vehicle in the same traveling direction as an ego vehicle is collected and managed.

A vehicle having relevance to an ego vehicle in performing the minimal risk maneuver mode, that is, a vehicle in a distance within which the vehicle may influence the driving path of an ego vehicle or may be influenced by the driving path when performing the minimal risk maneuver mode, is selected as a driving negotiation target.

Referring to FIG. 3C, vehicles N1, N2, N3, N4, N5, N6, N7, and N8 are selected as driving negotiation targets. As illustrated in FIG. 3D, information including a vehicle ID, a relative location, a speed, and acceleration is managed.

FIG. 3E illustrates a process of generating a driving negotiation target list. In step S310, surrounding vehicle information is received through V2X communication, and the surrounding vehicle information is updated. In step S320, the obtained surrounding vehicle information and high precision map information are fused. In step S330, a driving negotiation target list is generated and updated. A process of generating the driving negotiation target list is performed again whenever a surrounding vehicle information message is received through V2X communication or in a preset cycle, so that the driving negotiation target list is updated.

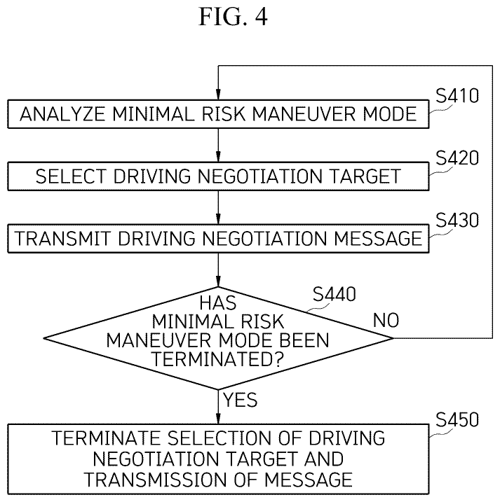

FIG. 4 illustrates a process of selecting a driving negotiation target and transmitting a driving negotiation message according to an embodiment of the present disclosure.

The process of selecting a driving negotiation target and transmitting a driving negotiation message according to an embodiment of the present disclosure includes step S410 of analyzing a minimal risk maneuver mode, step S420 of selecting a driving negotiation target, step S430 of transmitting a driving negotiation message, step S440 of checking whether the minimal risk maneuver mode has been terminated, and step S450 of terminating the selection of a driving negotiation target and the transmission of a message when the minimal risk maneuver mode is terminated.

When an emergency situation occurs in a process of generating and updating a driving negotiation target list, the minimal risk maneuver function unit of an ego vehicle initiates an operation, determines a minimal risk maneuver mode by considering the emergency situation and driving conditions, and performs vehicle control in order to achieve the minimal risk maneuver mode.

When determining the minimal risk maneuver mode, the minimal risk maneuver function unit of the ego vehicle selects a driving negotiation target, among surrounding vehicles in the driving negotiation target list, by considering mode information, a minimal risk maneuver driving path, and stop target point information, and performs driving negotiation with the selected driving negotiation target by transmitting, to the selected driving negotiation target, a driving negotiation message including driving cooperation contents.

After transmitting the driving negotiation message, the minimal risk maneuver function unit of the ego vehicle checks whether the execution of a minimal risk maneuver mode has been completed, and repeatedly performs the minimal risk maneuver mode from the analysis of the minimal risk maneuver mode if the execution of the minimal risk maneuver mode has not been completed.

The minimal risk maneuver mode is repeatedly determined until the ego vehicle is fully stopped. When there is a change in the driving conditions or the emergency situation, the minimal risk maneuver mode is also changed.

For example, when a serious failure occurs in an ego vehicle while the ego vehicle travels along a right lane, a minimal risk maneuver mode may be changed into the emergency stop mode. In this case, a driving negotiation target needs to be updated as a target that complies with the emergency stop mode. A driving negotiation message that is transmitted to the driving negotiation target also needs to be changed (or updated) based on the changed minimal risk maneuver mode.

Accordingly, the minimal risk maneuver mode is periodically analyzed up to the time when the minimal risk maneuver mode is terminated. The process of selecting a driving negotiation target and updating a driving negotiation message is repeatedly performed.

That is, when the minimal risk maneuver mode is determined, the process of selecting a driving negotiation target and transmitting a driving negotiation message is periodically repeated. When the minimal risk maneuver mode is completed, the aforementioned process is terminated.

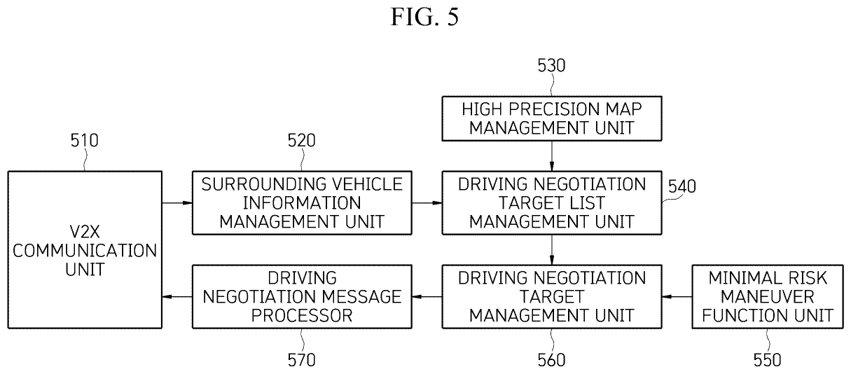

FIG. 5 illustrates a driving negotiation system for the minimal risk maneuver modes according to an embodiment of the present disclosure.

A V2X communication unit 510 receives information from a surrounding vehicle, transmits the information to a surrounding vehicle information management unit 520, receives a driving negotiation message from a driving negotiation message processor 570, and transmits the driving negotiation message to a surrounding vehicle.

A driving negotiation target list management unit 540 generates a driving negotiation target list by fusing the surrounding vehicle information received from the surrounding vehicle information management unit 520 and map information received from a high precision map management unit 530, and transmits the driving negotiation target list to a driving negotiation target management unit 560.

When a minimal risk maneuver is performed, the driving negotiation target management unit 560 selects a driving negotiation target by using the driving negotiation target list based on a minimal risk maneuver mode.

Whether to perform a minimal risk maneuver is determined based on a command signal that is received from a minimal risk maneuver function unit 550.

When the driving negotiation target is selected, the driving negotiation message processor 570 generates a driving negotiation message, and transmits the driving negotiation message to the driving negotiation target through the V2X communication unit 510.

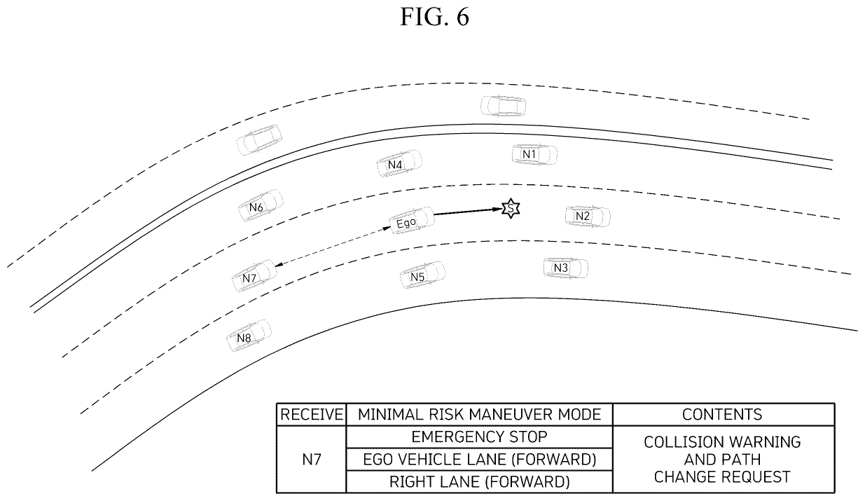

FIG. 6 illustrates a driving negotiation target vehicle and a driving negotiation message when the minimal risk maneuver mode for the emergency stop is performed according to an embodiment of the present disclosure.

When an emergency situation occurs and an ego vehicle determines the emergency stop as a minimal risk maneuver mode, the ego vehicle determines a path for completing the emergency stop.

In the emergency stop, the ego vehicle is very rapidly decelerated and stopped. Accordingly, there is a high risk of an accident attributable to the collision of a vehicle which travels behind the ego vehicle. After the emergency stop is completed, a pass along a corresponding lane becomes impossible because the corresponding lane is blocked.

Accordingly, the ego vehicle informs a vehicle (e.g., N7) which travels behind the ego vehicle of a situation of the emergency stop. The vehicle which travels behind the ego vehicle prepares for the emergency stop of the ego vehicle based on information received from the ego vehicle, expects that the ego vehicle will block a corresponding lane, and travels along a path that avoids the corresponding lane.

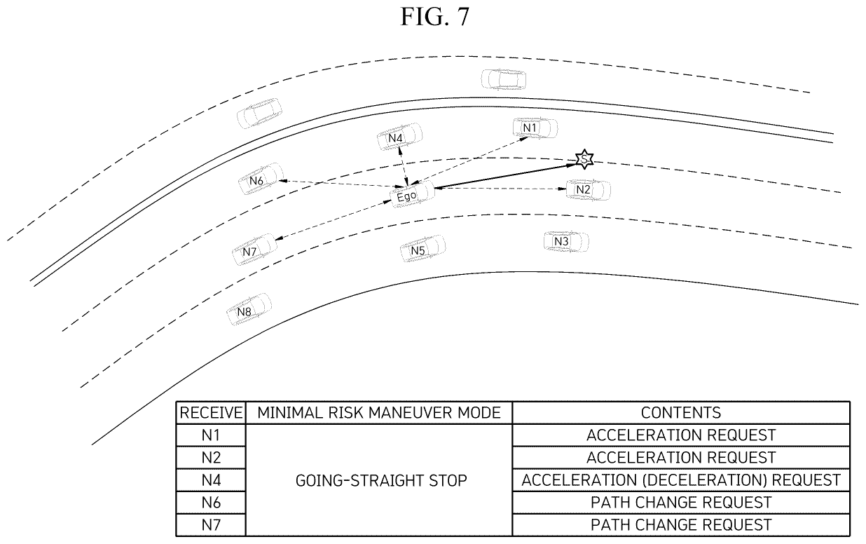

FIG. 7 illustrates a driving negotiation target vehicle and a driving negotiation message when the minimal risk maneuver mode for the going-straight stop is performed according to an embodiment of the present disclosure.

When an emergency situation occurs and an ego vehicle determines the going-straight stop as the minimal risk maneuver mode, the ego vehicle determines a path for completing the going-straight stop.

An ego vehicle stops in a current ego vehicle driving lane or a side lane thereof because the going-straight stop is performed in a situation in which transverse control has not been performed.

In order to complete the minimal risk maneuver mode safely and rapidly, the ego vehicle performs driving negotiations in order to travel up to a corresponding path without interference with a surrounding vehicle because it is important for the ego vehicle to travel up to the corresponding path without interference with the surrounding vehicle.

Furthermore, after the going-straight stop is completed, a pass through which a vehicle travels along the corresponding lane (e.g., one or more lanes) becomes impossible because the ego vehicle blocks the corresponding lane.

Referring to FIG. 7, an ego vehicle stops in two lanes. Accordingly, the ego vehicle requests vehicles N1 and N2, which may become obstacles to a going-straight stop path on the basis of a driving direction thereof, to accelerate and secure a space.

At the same time, the ego vehicle requests a vehicle N4, which travels along a left lane of the going-straight stop path of the ego vehicle, to decelerate or accelerate in order to avoid a collision against the vehicle N4.

The ego vehicle notifies vehicles N6 and N7, which travel behind the ego vehicle, that the ego vehicle will soon block a road so that the vehicles N6 and N7 can generate an avoidance path.

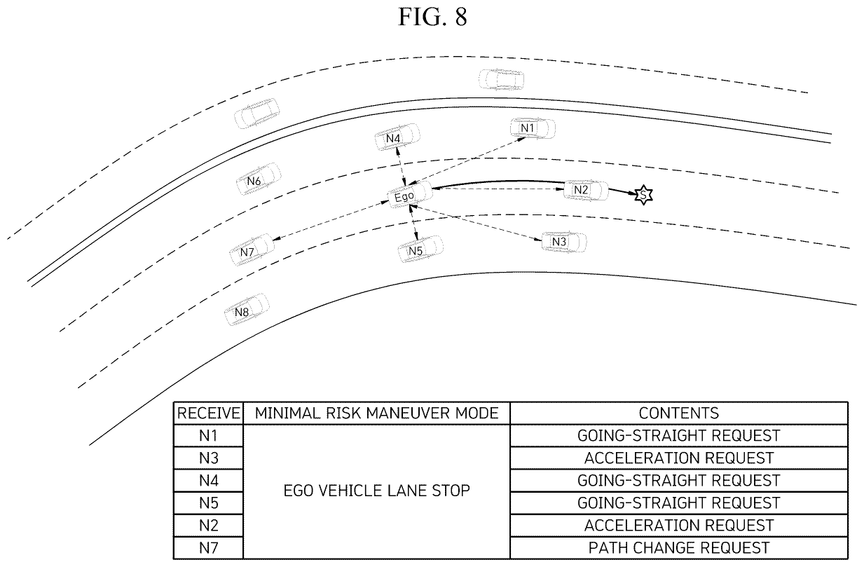

FIG. 8 illustrates a driving negotiation target vehicle and a driving negotiation message when the minimal risk maneuver mode for the ego vehicle lane stop is performed according to an embodiment of the present disclosure.

When an emergency situation occurs and an ego vehicle determines the ego vehicle lane stop as the minimal risk maneuver mode, the ego vehicle determines a path for completing the ego vehicle lane stop.

The ego vehicle stops in a current driving lane because longitudinal/transverse control can be performed on the ego vehicle lane stop.

In order to complete the minimal risk maneuver mode safely and rapidly, the ego vehicle performs driving negotiations in order to achieve the ego vehicle lane stop because it is important for the ego vehicle to travel up to a corresponding path without interference with a surrounding vehicle.

Furthermore, after the ego vehicle lane stop is completed, a pass through which a vehicle travels along the corresponding lane becomes impossible because the ego vehicle blocks the corresponding lane.

In FIG. 8, an ego vehicle requests a vehicle N2, which may become an obstacle to an ego vehicle lane parking path on the basis of a driving direction thereof, to accelerate and secure a space.

At the same time, the ego vehicle requests vehicles N1, N4, N3, and N5, which travel along left and right lanes of the traveling lane of the ego vehicle, to not change their lanes into the traveling lane of the ego vehicle.

The ego vehicle notifies a vehicle N7, which travels behind the ego vehicle, that the ego vehicle will soon block a road so that the vehicle N7 can generate an avoidance path.

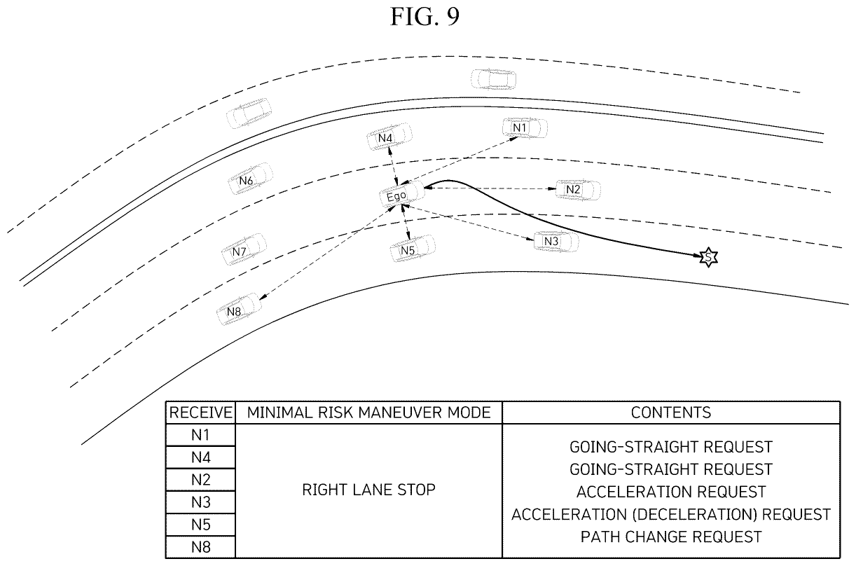

FIG. 9 illustrates a driving negotiation target vehicle and a driving negotiation message when the minimal risk maneuver mode for the ego vehicle lane stop is performed according to an embodiment of the present disclosure.

When an emergency situation occurs and an ego vehicle determines the right lane stop as the minimal risk maneuver mode, the ego vehicle determines a path for completing the right lane stop.

The ego vehicle stops in a right lane because longitudinal/transverse control can be performed on the right lane stop.

In order to complete the minimal risk maneuver mode safely and rapidly, the ego vehicle performs driving negotiations in order to achieve the right lane stop because it is important for the ego vehicle to travel up to a corresponding path without interference with a surrounding vehicle.

After the right lane stop is completed, a pass through which a vehicle travels along the corresponding lane becomes impossible because the ego vehicle blocks the corresponding lane (i.e., a right lane of the current driving lane of the ego vehicle).

Referring to FIG. 9, an ego vehicle requests vehicles N2 and N3, which may become obstacles to a right lane stop path on the basis of a driving direction thereof, to accelerate and secure a space.

At the same time, the ego vehicle transmits notification to vehicles N1 and N4, which travel along a left lane of the ego vehicle, so that the vehicles N1 and N4 do not enter the traveling path of the ego vehicle.

The ego vehicle requests a vehicle N5 on the right of the ego vehicle to accelerate or decelerate, and determines deceleration or acceleration, based on a relative distance to the vehicle N5 and the speed and acceleration of the vehicle N5, in order to secure a space for a lane change.

The ego vehicle notifies a vehicle N8, which travels behind the ego vehicle, that the ego vehicle will soon block a road so that the vehicle N8 can generate an avoidance path.

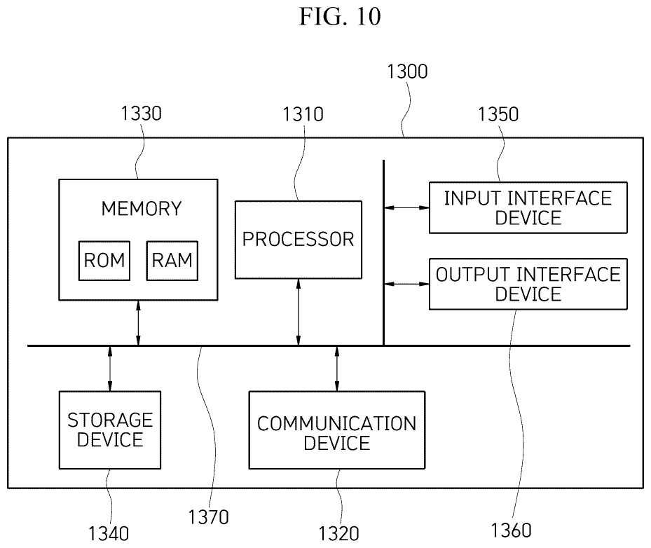

FIG. 10 is a block diagram illustrating a computer system for implementing the method according to an embodiment of the present disclosure.

Referring to FIG. 10, a computer system 1300 may include at least one of a processor 1310, memory 1330, an input interface device 1350, an output interface device 1360, and a storage device 1340 which communicate with each other through a bus 1370. The computer system 1300 may further include a communication device 1320 connected to a network. The processor 1310 may be a central processing unit (CPU) or may be a semiconductor device that executes instructions stored in the memory 1330 or the storage device 1340. The memory 1330 and the storage device 1340 may include various types of volatile or nonvolatile storage media. For example, the memory may include read only memory (ROM) and random access memory (RAM). In an embodiment of the present specification, the memory may be disposed inside or outside the processor, and may be connected to the processor through various known means. The memory includes various types of volatile or nonvolatile storage media, and may include read-only memory (ROM) or random access memory (RAM), for example.

Accordingly, an embodiment of the present disclosure may be implemented as a method implemented in a computer or may be implemented as a non-transitory computer-readable medium in which a computer-executable instruction has been stored. In an embodiment, when being executed by a processor, a computer-readable instruction may perform a method according to at least one aspect of the present specification.

The communication device 1320 may transmit or receive a wired signal or a wireless signal.

Furthermore, the method according to an embodiment of the present disclosure may be implemented in the form of a program instruction which may be executed through various computer means, and may be recorded on a computer-readable medium.

The computer-readable medium may include a program instruction, a data file, and a data structure alone or in combination. A program instruction recorded on the computer-readable medium may be specially designed and constructed for an embodiment of the present disclosure or may be known and available to those skilled in the computer software field. The computer-readable medium may include a hardware device configured to store and execute the program instruction. For example, the computer-readable medium may include magnetic media such as a hard disk, a floppy disk, and a magnetic tape, optical media such as CD-ROM and a DVD, magneto-optical media such as a floptical disk, ROM, RAM, and flash memory. The program instruction may include not only a machine code produced by a compiler, but a high-level language code capable of being executed by a computer through an interpreter.

The embodiments of the present disclosure have been described in detail, but the scope of rights of the present disclosure is not limited thereto. A variety of modifications and changes made by those skilled in the art using the basic concept of the present disclosure defined in the appended claims are also included in the scope of rights of the present disclosure.

A system for managing a driving negotiation target for a minimal risk maneuver according to an embodiment of the present disclosure includes an input interface device configured to receive surrounding vehicle information from surrounding vehicles of an ego vehicle through V2X communication and to receive map information from a high precision map management unit, memory in which a program that selects a driving negotiation target based on the surrounding vehicle information and the map information has been stored, and a processor configured to execute the program. The processor selects the driving negotiation target, among the surrounding vehicles, by considering a minimal risk maneuver mode.

The surrounding vehicle information includes vehicle ID information, absolute location information, speed information, and acceleration information.

The processor generates base information for selecting the driving negotiation target based on the surrounding vehicle information and the map information.

The processor selects, as the driving negotiation target, the surrounding vehicle that is expected to influence or to be influenced by a driving path of the ego vehicle when performing a minimal risk maneuver by considering the minimal risk maneuver mode.

A method of managing a driving negotiation target for a minimal risk maneuver according to an embodiment of the present disclosure includes steps (a) of receiving surrounding vehicle information and high precision map information and (b) of selecting a driving negotiation target in a minimal risk maneuver mode based on the surrounding vehicle information and the high precision map information.

The step (a) includes receiving the surrounding vehicle information including vehicle ID information, absolute location information, speed information, and acceleration information.

The step (b) includes generating base information for selecting the driving negotiation target, based on the surrounding vehicle information and the high precision map information.

The step (b) includes selecting, as the driving negotiation target, a surrounding vehicle that is expected to influence or to be influenced by a driving path of the ego vehicle when performing a minimal risk maneuver by considering the minimal risk maneuver mode.

A system for managing a driving negotiation message for a minimal risk maneuver according to an embodiment of the present disclosure includes an input interface device configured to receive driving negotiation target information, memory in which a program that generates a driving negotiation message by considering the driving negotiation target information and transmits the driving negotiation message has been stored, and a processor configured to execute the program. The processor generates the driving negotiation message by considering a minimal risk maneuver mode.

The processor generates the driving negotiation message for collision warning and a path change request when the minimal risk maneuver mode corresponds to an emergency stop.

The processor generates the driving negotiation message including at least any one of an acceleration request, a deceleration request, and a path change request by considering the driving negotiation target information when the minimal risk maneuver mode corresponds to a going-straight stop.

The processor generates the driving negotiation message including at least any one of a going-straight request, an acceleration request, and a path change request by considering the driving negotiation target information when the minimal risk maneuver mode corresponds to an ego vehicle lane stop.

The processor generates the driving negotiation message including at least any one of a going-straight request, an acceleration request, a deceleration request, and a path change request by considering the driving negotiation target information when the minimal risk maneuver mode corresponds to a right lane stop.

A method of managing a driving negotiation message for a minimal risk maneuver according to an embodiment of the present disclosure steps (A) of receiving driving negotiation target information and a minimal risk maneuver mode and (B) of generating a driving negotiation message by considering the driving negotiation target information and the minimal risk maneuver mode.

The step (B) includes generating the driving negotiation message for collision warning and a path change request when the minimal risk maneuver mode corresponds to an emergency stop.

The step (B) includes generating the driving negotiation message including at least any one of an acceleration request, a deceleration request, and a path change request by considering the driving negotiation target information when the minimal risk maneuver mode corresponds to a going-straight stop.

The step (B) includes generating the driving negotiation message including at least any one of a going-straight request, an acceleration request, and a path change request by considering the driving negotiation target information when the minimal risk maneuver mode corresponds to an ego vehicle lane stop.

The step (B) includes generating the driving negotiation message including at least any one of a going-straight request, an acceleration request, a deceleration request, and a path change request by considering the driving negotiation target information when the minimal risk maneuver mode corresponds to a right lane stop.

What is claimed is:

1. A system for managing a driving negotiation message for a minimal risk maneuver, the system comprising:
an input interface device configured to receive driving negotiation target information;
memory in which a program that generates a driving negotiation message by considering the driving negotiation target information and transmits the driving negotiation message has been stored; and
a processor configured to execute the program,
wherein the processor generates the driving negotiation message by considering a minimal risk maneuver mode.

2. The system of claim 1, wherein the processor generates the driving negotiation message for collision warning and a path change request when the minimal risk maneuver mode corresponds to an emergency stop.

3. The system of claim 1, wherein the processor generates the driving negotiation message comprising at least any one of an acceleration request, a deceleration request, and a path change request by considering the driving negotiation target information when the minimal risk maneuver mode corresponds to a going-straight stop.

4. The system of claim 1, wherein the processor generates the driving negotiation message comprising at least any one of a going-straight request, an acceleration request, and a path change request by considering the driving negotiation target information when the minimal risk maneuver mode corresponds to an ego vehicle lane stop.

5. The system of claim 1, wherein the processor generates the driving negotiation message comprising at least any one of a going-straight request, an acceleration request, a deceleration request, and a path change request by considering the driving negotiation target information when the minimal risk maneuver mode corresponds to a right lane stop.

6. A method of managing a driving negotiation message for a minimal risk maneuver, the method performed by a system for managing a driving negotiation message and comprising steps of:
(A) receiving driving negotiation target information and a minimal risk maneuver mode; and
(B) generating a driving negotiation message by considering the driving negotiation target information and the minimal risk maneuver mode.

7. The method of claim 6, wherein the step (B) comprises generating the driving negotiation message for collision warning and a path change request when the minimal risk maneuver mode corresponds to an emergency stop.

8. The method of claim 6, wherein the step (B) comprises generating the driving negotiation message comprising at least any one of an acceleration request, a deceleration request, and a path change request by considering the driving negotiation target information when the minimal risk maneuver mode corresponds to a going-straight stop.

9. The method of claim 6, wherein the step (B) comprises generating the driving negotiation message comprising at least any one of a going-straight request, an acceleration request, and a path change request by considering the driving negotiation target information when the minimal risk maneuver mode corresponds to an ego vehicle lane stop.

10. The method of claim 6, wherein the step (B) comprises generating the driving negotiation message comprising at least any one of a going-straight request, an acceleration request, a deceleration request, and a path change request when the minimal risk maneuver mode corresponds to a right lane stop.
